(19) United States
(12) Patent Application Publication
(10) Pub. No.: US 2012/0031572 A1
(43) Pub. Date: Feb. 9, 2012

(54) Low Profile Roller Shade Control Unit

(76) Inventors: Philip Ng, Thornhill (CA); Norman Wills, Mississauga (CA)

(21) Appl. No.: 12/850,333

(22) Filed: Aug. 4, 2010

(51) Int. Cl. E06B 9/68; E06B 9/58

(52) U.S. Cl. 160/321

(57) ABSTRACT

There is disclosed an improved roller shade control unit having a reduced profile for use with a roller tube and roller chain. The improved roller shade control unit including a tube housing for coupling to the roller tube and a sprocket for coupling the tube housing to the chain.

The sprocket has a peripheral edge configured to couple to the chain. A chain guide for keeping the chain coupled to the sprocket is provided, said chain guide comprising a flat member having a bottom and a side, an aperture dimensioned to contain the sprocket being formed on the side. The tube housing has a barrel portion and an extended edge portion projecting radially from an end of the barrel portion, said extended edge portion configured to cover the sprocket, said extended edge portion having at least one cut out dimensioned to permit a portion of the chain to pass there through.

### FIELD OF THE INVENTION

The invention relates generally to control units for controlling the up and down movement of a roller shade by means of a chain.

### BACKGROUND OF THE INVENTION

Roller shades often incorporate a chain operated control unit for raising and lowering the blind or shade. The control unit generally incorporates a sprocket coupled to a roller tube barrel, both of which are mounted to some sort of support bracket. The roller tube barrel is inserted and mounted to one end of the roller tube which supports the blind. The roller tube barrel is in turn mounted to sprocket such that rotation of the sprocket causes the roller tube barrel to rotate in response, with the effect of raising or lowering the blind. A chain loop consisting of a plurality of beads on a string is coupled to the sprocket and used to rotate the sprocket. To prevent the chain from jamming or coming loose, the control unit is generally provided with some sort of chain guide designed to limit the movement of the chain and to keep the chain coupled to the sprocket.

This system of control unit is quite successful and common in the marketplace; however, it does suffer from a few drawbacks. In particular, there is always a gap separating the end of the roller tube and the support bracket holding the sprocket and roller tube barrel. As a result, a large light gap is formed between the edge of the window and the blind. Also, the design is not foolproof in preventing the chain from jamming against the edge of the blind in the control mechanism. Therefore, and improved roller shade control unit is desired.

### SUMMARY OF THE INVENTION

In accordance with one aspect of the present invention, there is provided an improved roller shade control unit having a reduced profile resulting in a much reduced light gap. The improved roller shade control unit made in accordance with the present invention includes a flat plate and a roller tube mount rotatably mounted to the flat plate. The roller tube mount has a barrel portion with an extended edge portion extending radialy from one end of the barrel portion which rotates with the barrel portion. The control unit further includes a sprocket mounted between the flat plate and the roller tube mount. The extended edge portion of the roller tube mount is dimensioned to cover the sprocket to a peripheral edge of the sprocket.

In accordance with another aspect of the present invention, there is provided an improved roller shade control unit having a reduced profile for use with a roller tube and roller chain. The improved roller shade control unit including a tube housing for coupling to the roller tube and a sprocket for coupling the tube housing to the chain. The sprocket has a peripheral edge configured to couple to the chain. A chain guide for keeping the chain coupled to the sprocket is provided, said chain guide comprising a flat member having a bottom and a side, an aperture dimensioned to contain the sprocket being formed on the side. The tube housing has a barrel portion and an extended edge portion projecting radially from an end of the barrel portion, said extended edge portion configured to cover the sprocket, said extended edge portion having at least one cut out dimensioned to permit a portion of the chain to pass there through.

With the foregoing in view, and other advantages as will become apparent to those skilled in the art to which this invention relates as this specification proceeds, the invention is herein described by reference to the accompanying drawings forming a part hereof, which includes a description of the preferred typical embodiment of the principles of the present invention.

### DESCRIPTION OF THE DRAWINGS

FIG. 1 is an exploded view of a roller shade control unit made in accordance with the present invention.

FIG. 2 is a front view of a roller shade control unit made in accordance with the present invention.

FIG. 3 is a side view partly in section of the roller shade having the control unit made in accordance with the present invention. In the drawings like characters of reference indicate corresponding parts in the different figures.

### DETAILED DESCRIPTION OF THE INVENTION

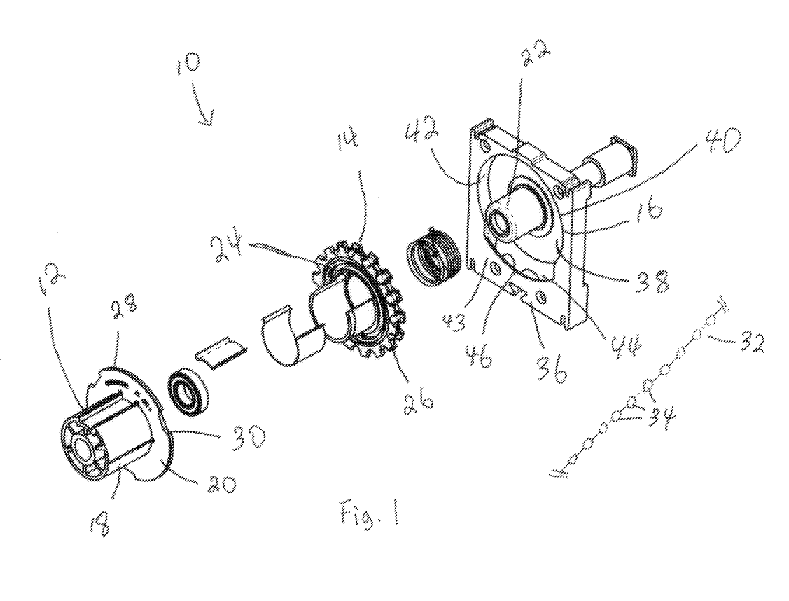

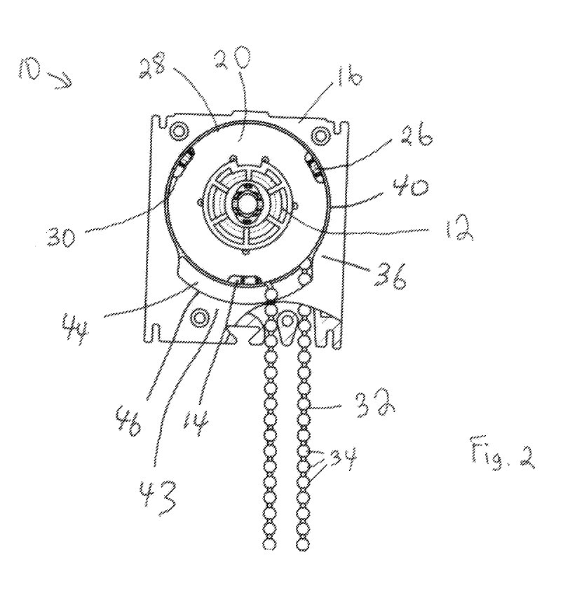

Referring to FIG. 1, a roller shade control unit made in accordance with the present invention is shown generally as item 10 and includes roller tube mount 12, flat mounting plate 16 and sprocket 14 mounted between the roller tube mount and the flat mounting plate. The roller tube mount includes a barrel portion 18 and an extended edge portion 20 which extends radially away from the barrel portion. Roller tube mount 12 and sprocket 14 are both coaxially aligned and rotatably mounted to mounting element 22 of flat plate 16 such that both the roller tube mount and the sprocket can rotate relative to flat plate 16. Flat plate 16 forms part of a mounting bracket (not shown) for mounting to a wall or window frame (not shown). Preferably roller tube mount 18 is made from one injection molded piece such that extended edge portion 20 and barrel portion 18 are integral and rotate together. Sprocket 14 is circular and has a central portion 24 which is mountable to mounting element 22 and it has a peripheral edge 26 at the peripheral edge of the sprocket. Extended portion 20 of roller tube mount 12 is sufficiently dimensioned (i.e. wide) to cover over sprocket 14 such that edge 28 of the extended portion overlaps and covers over sprocket 14 right to peripheral edge 26 so that the peripheral edge is covered by the extended portion. As best seen in FIG. 2, extended portion 20 has cut out sections 30 on peripheral edge 28 which are dimensioned to permit a portion of chain 32 to pass through the cut out section. In particular, cut out section 30 should be a little larger than the diameter of beads 34 making up chain 32 to permit the chain to be looped onto peripheral edge 26 of sprocket 14 by passing a portion of the chain through cut out (apertures) 30.

Mount plate 16 has a chain guide 36 formed therein (or mounted thereto) which consists of a circular aperture 38 having a diameter sufficient to receive sprocket 14. Aperture 38 is defined by wall 42 and has edge 40. Aperture 38 and sprocket 14 are dimensioned such that peripheral edge 26 of sprocket 14 is positioned immediately adjacent wall 42 and edge 40 of chain guide 36. Extended portion 20 is dimensioned such that peripheral edge portion 28 of the extended portion is positioned adjacent edge 40 so that sprocket 14 is entirely covered by edge portion 20 and contained within aperture 38. As best seen in FIGS. 1 and 2, chain guide 36 has a lower portion 43 which has a gap 44 separating edge portion 46 from the sprocket 14. Gap 44 is dimensioned such that a loop of chain 32 can pass through the gap so that it can be threaded onto sprocket 14.

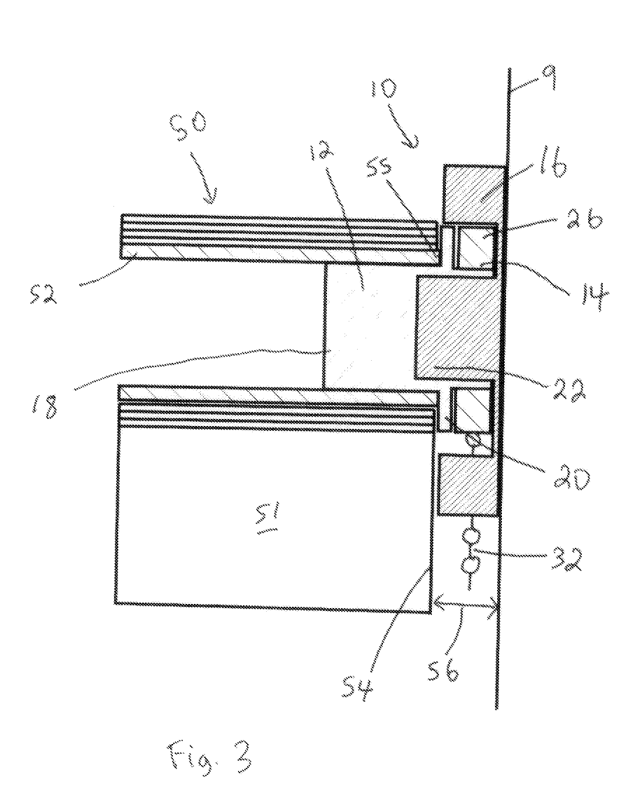

Referring now to FIG. 3, when assembled, control unit 10 is mounted to a wall 9 and roller tube 52 is inserted onto barrel portion 18 of roller tube mount 12. End 55 of roller tube 52 is pushed against roller tube mount 12 such that end 55 either abuts or is immediately adjacent extended portion 20. Since extended portion 20 rotates with roller tube mount 12, and therefore roller tube 52, it is less likely that edge 54 will jam in socket 14 since it is separated from the socket by extended portion 20. By forming extended portion 20 onto roller tube mount 12, the whole control unit 10 can be made with a very narrow profile such that light gap 56 is as narrow as possible. Indeed light gap 56 can be made to be approximately the same dimensions as the width of chain guide and plate 16.

A specific embodiment of the present invention has been disclosed; however, several variations of the disclosed embodiment could be envisioned as within the scope of this invention. It is to be understood that the present invention is not limited to the embodiments described above, but encompasses any and all embodiments within the scope of the following claims.

Therefore, what is claimed is:

1. A roller shade control mechanism for raising and lowering a blind by engaging a chain, said roller shade control mechanism comprising:
A flat plate;
A roller tube mount rotatably mounted to the flat plate, said roller tube mount having a barrel portion and an extended edge portion extending radially from one end of the barrel portion and rotating therewith;
A sprocket mounted between the flat plate and the roller tube mount, the extended edge portion of the roller tube mount being dimensioned to cover the sprocket to a peripheral edge of the sprocket.

2. The roller shade control mechanism of claim 1 wherein the extended edge portion has at least one “cut out” on a peripheral edge of the extended edge portion, the cut out dimensioned to permit a portion of the chain to pass there through.

3. The roller shade control mechanism of claim 1 further comprising a chain guide mounted to the flat plate, the sprocket being contained in an aperture formed in the chain guide, said aperture having an edge, the extended edge portion of the roller tube dimensioned to extend to the edge of the aperture.

4. The roller shade control mechanism of claim 3 wherein the extended edge portion has at least one “cut out” on a peripheral edge thereof, the cut out dimensioned to permit a portion of the chain to pass therethrough.

5. The roller shade control mechanism of claim 4 wherein a bottom portion of the chain guide has a gap separating the edge from the sprocket, the gap dimensioned to permit a portion of the chain to pass therethrough.

6. A roller shade control mechanism for raising and lowering a roller blind having a roller tube by engaging a continuous loop chain, said chain drive mechanism comprising:
a tube housing for coupling to the roller tube;
a sprocket for coupling the tube housing to the chain, the sprocket having a peripheral edge configured to couple to the chain;
a chain guide for keeping the chain coupled to the sprocket, said chain guide comprising a flat member having a bottom and a side, an aperture dimensioned to contain the sprocket being formed on the side;
the tube housing having a barrel portion and an extended edge portion projecting radially from an end of the barrel portion, said extended edge portion configured to cover the sprocket, said extended edge portion having at least one cut out dimensioned to permit a portion of the chain to pass there through.
